(19) United States
(12) Patent Application Publication
(10) Pub. No.: US 2024/0430884 A1
(43) Pub. Date: Dec. 26, 2024

(54) METHODS, COMMUNICATIONS DEVICES AND INFRASTRUCTURE EQUIPMENT

(71) Applicant: Sony Group Corporation, Tokyo (JP)

(72) Inventors: Yassin Aden AWAD, Basingstoke (GB); Shin Horng WONG, Basingstoke (GB); Yuxin WEI, Basingstoke (GB); Vivek SHARMA, Basingstoke (GB); Hideji WAKABAYASHI, Basingstoke (GB)

(73) Assignee: Sony Group Corporation, Tokyo (JP)

(21) Appl. No.: 18/683,515

(22) PCT Filed: Jul. 19, 2022
(86) PCT No.: PCT/EP2022/070229

§ 371 Date: Feb. 14, 2024

(30) Foreign Application Priority Data
Aug. 23, 2021 (EP) 21192677.9

(51) Int. Cl. H04W 72/1263; H04L 5/00; H04W 72/23

(52) U.S. Cl. CPC H04W 72/1263; H04L 5/0007; H04W 72/23

(57) ABSTRACT

A communications device receives a frequency resource indicator to configure a first frequency domain portion of communications resources of a wireless access interface which can be used for communications between the communications device and a wireless network. The frequency resource indicator indicates a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources. In response, the communications device configures the first frequency domain portion of the communications resources in accordance with the configuration indicated by the frequency resource indicator.

### BACKGROUND

### Field of Disclosure

The present disclosure relates to communications devices, infrastructure equipment and methods for the efficient use of communications resources by a communications device in a wireless communications network. The present disclosure claims the Paris Convention priority of European patent application number EP21192677.9 filed on 23 Aug. 2021, the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to receive signals from a wireless communications network via a wireless access interface provided by the wireless communications network. The communications device receives a frequency resource indicator indicating to the communications device to configure a first frequency domain portion of communications resources of the wireless access interface which can be used for communications between the communications device and the wireless communications network. The frequency resource indicator indicates a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources. In response, the communications device configures the first frequency domain portion of the communications resources in accordance with the configuration indicated by the frequency resource indicator. The configuration of the first frequency domain portion of the communications resources is different from a configuration of another, second frequency portion of the communications resources.

As indicated above, and as will be appreciated by one skilled in the art, communications resources can be used for communications between a communications device and a wireless communications network (for example, uplink or downlink transmissions). Communications resources may be alternatively referred to as “physical resources”. For example, as will be appreciated by one skilled in the art, communications resources may include Physical Resource Blocks (PRBs). In any case, communications resources are formed from time and frequency resources of a wireless access interface. In one example, communications resources may be represented by Orthogonal Frequency Division Multiplexing (OFDM) symbols on a radio resource grid.

It will therefore be appreciated that a frequency domain portion of communications resources represents frequency domain resources of the communications resources. The frequency domain portion may represent a sub-set of the frequency domain resources. In some cases, the frequency domain portion is a bandwidth part.

The phrase “previously configured” communications resources which is used throughout this disclosure may include any configuration, arrangement or pattern of communications resources prior to the reception of the frequency resource indicator. The phrase “previously configured” communications resources may be used interchangeably with “legacy” communications resources throughout this disclosure.

Embodiments of the present technique, which, in addition to methods of operating communications devices, relate to communications devices, circuitry for communications devices, computer programs, and computer-readable storage mediums, can allow for more efficient use of radio resources by a communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is a table defining 255 possible slot formats which can be indicated by a Slot Format Indicator (SFI);

FIG. 5 schematically represents a grid of radio communications resources;

FIG. 6 schematically represents a grid of radio communications resources for two bandwidth parts;

FIG. 7 illustrates a grid of communications resources with a legacy slot format for one bandwidth part and a grid of communications resources with an updated slot format for another bandwidth part in accordance with example embodiments;

FIG. 8 is based on FIG. 7 but additionally illustrates the combination of bandwidth parts according to example embodiments;

FIG. 9A is based on FIG. 7 but additionally illustrates an updated slot format with only flexible symbols according to example embodiments; and

FIG. 9B is based on FIG. 9A but additionally illustrates a downlink control indicator (DCI) scheduling a downlink transmission on the flexible symbols in the updated slot format according to example embodiments.

### DETAILED DESCRIPTION OF THE EMBODIMENTS

### Long Term Evolution Advanced Radio Access Technology (4G)

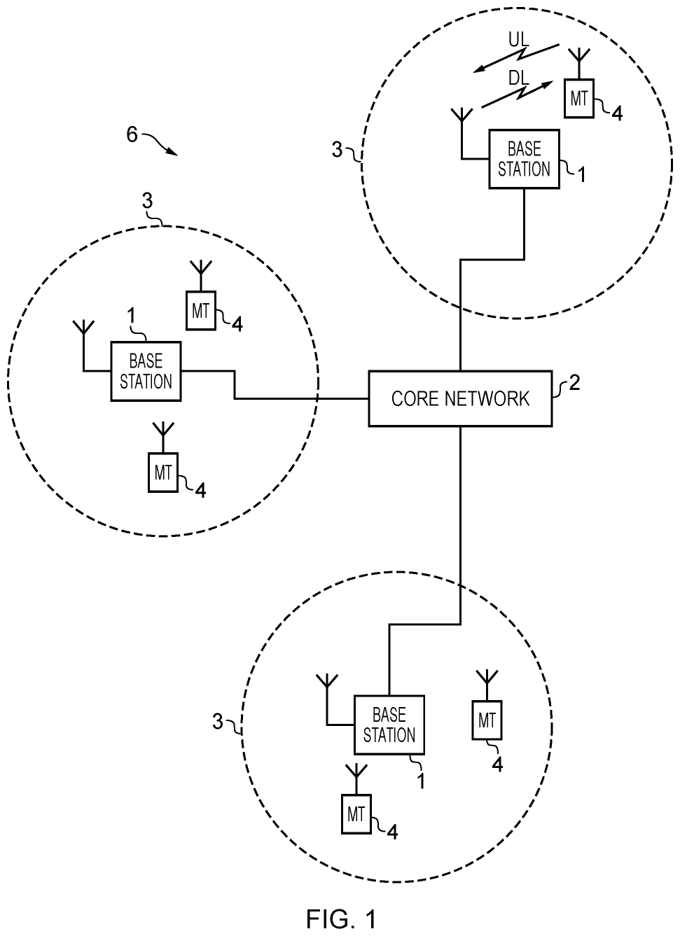

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

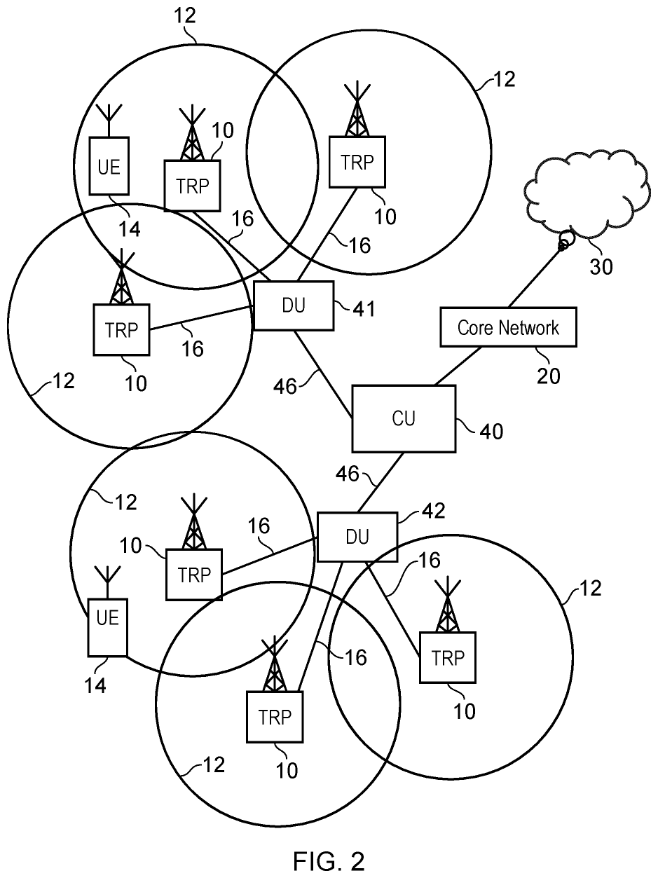

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

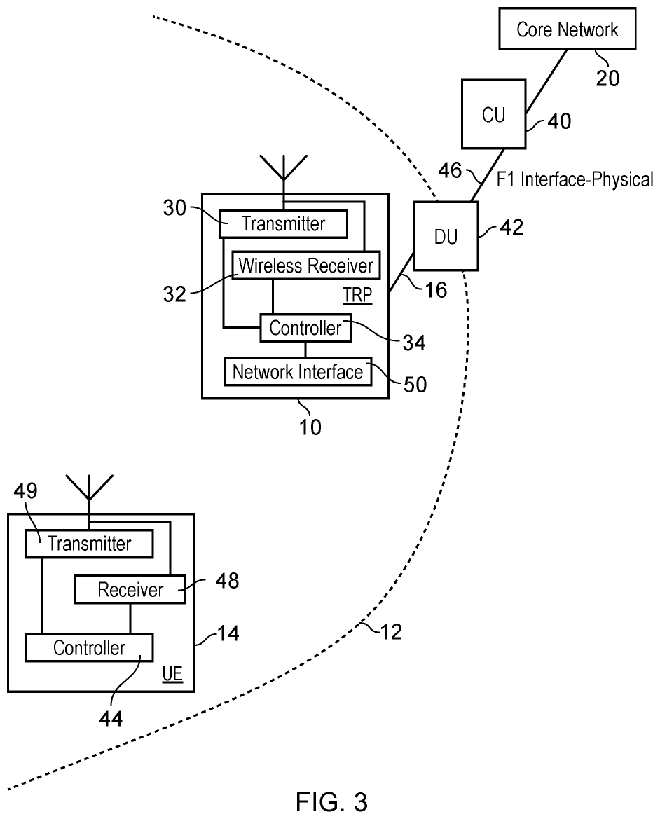

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

3GPP has already completed the basic version of 5G (NR) in Rel-15. In Rel-16, some important enhancements have been incorporated such as 2-step RACH, Industrial Internet of Things (IIoT), Ultra Reliable Low Latency Communications (URLLC), Cross-link Interference (CLI) handling for Time Division Duplex (TDD), basic positioning capability and NR-based Access to Unlicensed Spectrum. Further enhancements are being developed for Rel-17 with new services and enhanced user experience, such as Small Data Transmissions (SDT), Multicast and Broadcast Services (MBS), Reduced Capability UE and Positioning enhancement.

The NR system will be further developed in Rel-18, and one of the proposed features is to enhance duplexing operation for TDD by enabling Full Duplex operation in TDD, FD-TDD [2]. Currently, TDD operates in Half Duplex (HD) mode where the entire frequency band is switched to either downlink or uplink transmissions for a time period and can then switch to the other of downlink or uplink transmissions at a later time period, and thus the gNB or UE can either transmit or receive, but not both at the same time. The motivations for enhancing duplexing operation, at least for TDD, include:
Improving system capacity: In the current TDD system, some slots are only for transmissions in the downlink (DL) direction or only for transmissions in the uplink (UL) direction, where such slots are configured semi-statically. Hence, if there is less (or indeed no) data for transmission in one direction than the other, resources will not be used or at the least will be under-utilised. However, if resources can be used for either DL data or UL data, the resource utilisation in the system can be improved;
Reducing latency: In the current TDD system, a UE can receive DL data, but cannot transmit UL data at the same time, causing some delays. If a gNB or a UE is allowed to transmit and receive at the same time, the traffic latency can be improved; and
Improving uplink coverage: A UE usually is power-limited in the UL direction at the cell-edge. The coverage at the cell-edge can be improved if more time domain resources are assigned to UL transmissions (e.g. repetitions). However, if the UL direction is assigned more time resources, fewer time resources will therefore be left for the DL direction, and hence the system will become unbalanced. FD-TDD is able to help a UE be assigned more time resources as and when required, without sacrificing the DL resources.

A UE may operate according to HD-TDD or FD-TDD and/or a gNB may operate according to HD-TDD or FD-TDD depending on their respective capabilities. If a gNB operates according to FD-TDD, then that gNB (at least) can transmit and receive data/signals to/from a UE or multiple UEs at the same time on the same frequency band. If a UE operates according to FD-TDD, then that UE can transmit and receive data/signals to a wireless communications network at the same time on the same frequency band. FD-TDD from the system or gNB point of view is achieved for such UEs as follows:
For an HD-TDD UE, full duplex TDD is achieved at the gNB by scheduling a UE in the DL and scheduling another UE in the UL within the same OFDM symbol; In UE, RF switch is inserted in RF circuit. UE switches either uplink direction or downlink direction. Although this is simple hardware, enough isolation between uplink and downlink can be achieved.
For a FD-TDD UE, full duplex TDD is achieved both at the gNB and the UE, where the gNB can simultaneously schedule this UE in the DL and UL within the same OFDM symbol, but the DL and UL are scheduled in different frequency units (e.g. PRBs) of the system bandwidth. FD-TDD UEs therefore require more complex hardware compared to HD-TDD UEs. UE may have the frequency filter and self-cancellation for isolation between uplink and downlink.

Further aspects of full-duplex or flexible TDD operation can be found in European patent No. 3545716 [3], the contents of which are hereby incorporated by reference in their entirety.

### TDD Slot Configurations

As will be explained in more detail below, a radio frame in current NR systems contains a number of slots (Nₛₗₒₜ^{frame,μ}) depending on a subcarrier spacing (Δf) of a bandwidth part (BWP). For example, there are ten slots for a 15 KHz subcarrier spacing, twenty slots for a 30 KHz subcarrier spacing, and so on. Other structures are summarised in Table I below, which is reproduced from [4].

TABLE I
Slots per frame and number of OFDM symbols
per slot for different subcarrier spacing

| μ | Δf = 2^{μ} · 15[kHz] | N_{symb}^{slot} | Nₛₗₒₜ^{frame, μ} | Nₛₗₒₜ^{subframe, μ} |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |

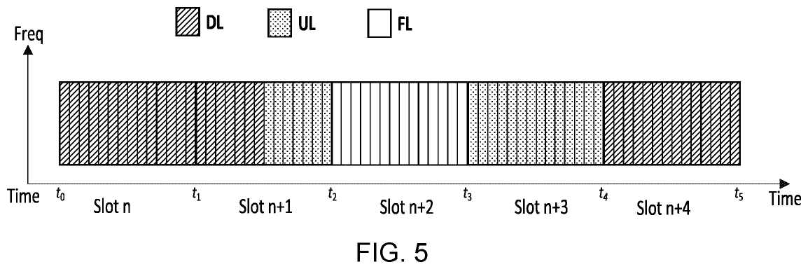

A slot format, as will be explained in more detail with reference to FIG. 5 below, refers to an arrangement or pattern of OFDM symbols in a slot, where each OFDM symbol (which may sometimes be referred to just as a “symbol”) can be configured as ‘Downlink’ (DL), ‘Flexible’ (FL), or ‘Uplink’ (UL). The UE receives data in a DL symbol and transmits data in an UL symbol. The FL symbol can be further indicated for use in either of the DL or the UL.

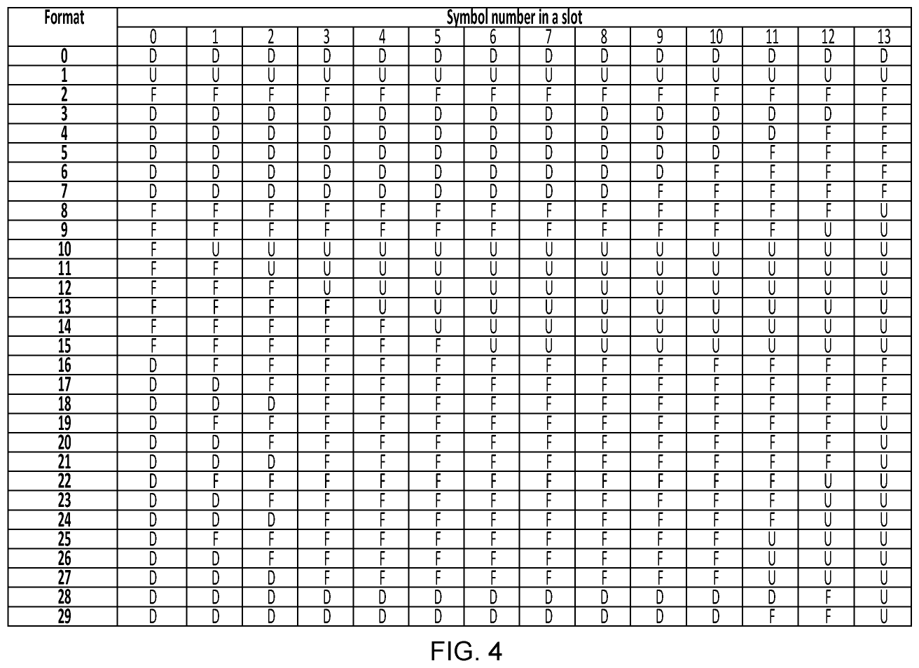

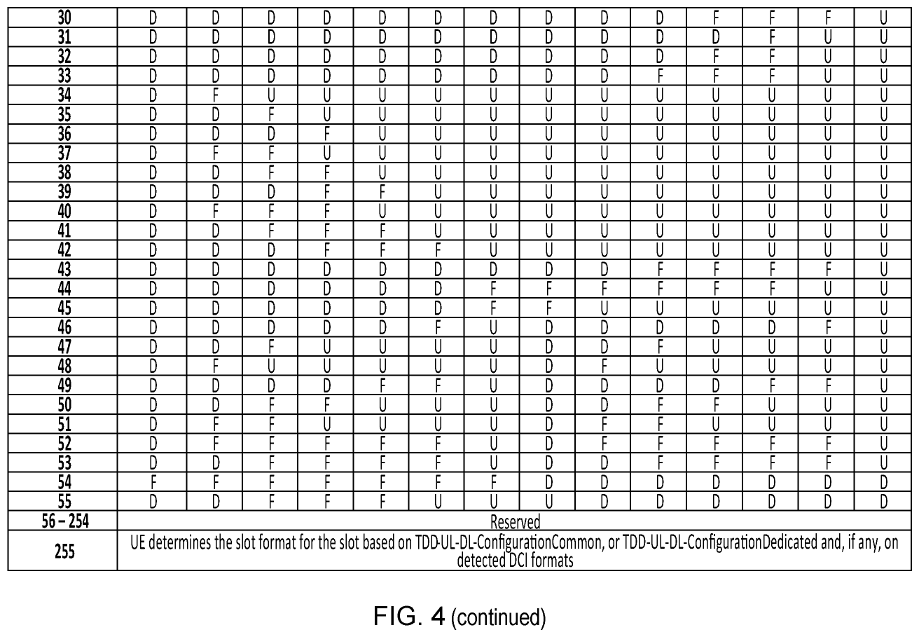

In the current TDD system, there are four ways to configure the slot format. These consist of two Radio Resource Control (RRC) configurations (i.e. semi-static configurations) and two dynamic configurations:
Cell Common semi-static slot format: The slot format is configured in the parameter tdd-UL-DL-ConfigurationCommon and is broadcast in SIB1. This enables a UE in Idle Mode or a UE that has just attached to the cell to determine the slot format of the cell, which would be defined together with other information, such as the location of other SIBs and common PDCCH and PRACH resources. The gNB can configure two slot format patterns that repeat periodically, where in each pattern, a period of P_{Cellcomon} slots are configured as follows:
   The first dₛₗₒₜₛ in the period are all DL symbols (dₛₗₒₜₛ can be zero);
   The slot after the first dₛₗₒₜₛ is a slot where the first d_{sym} are DL symbols;
   The last uₛₗₒₜₛ in the period are all UL symbols (uₛₗₒₜₛ can be zero);
   The slot before the last uₛₗₒₜₛ is a slot where the last u_{sym} are UL symbols; and
   The remaining OFDM symbols between these DL and UL symbols are FL symbols;
UE specific semi-static slot format: The slot format is configured in the RRC parameter TDD-UL-DL-ConfigDedicated, which is configured on a per-UE basis, i.e. after the UE has an RRC Connection to the network. Each slot format for a slot in a radio frame (10 ms) can be explicitly configured as follows:
   The first nrofDownlinkSymbols symbols in the slot are DL symbols;
   The last nrofUplinkSymbols symbols in the slot are UL symbols; and
   The remaining symbols in the slot are FL symbols;
Slot Format Indicator (SFI): The SFI is transmitted to a group of UEs using Group Common DCI (GC-DCI) Format 2_0, where the DCI is masked with an SFI-Radio Network Temporary Identifier (RNTI). The SFI is RRC configured with a Slot Format Combination, which is a subset of a 255 possible slot formats. That is, the network selects a subset of slot formats that can be dynamically indicated in the SFI. Each Slot Format in the Slot Format Combination is assigned a Slot Format Combination ID and the SFT signals this Slot Format Combination ID to the group of UEs. Currently up to 56 slot formats are defined for SFI, with a potential of up to 255 different slot formats, where each slot format identified with an index that indicates a unique combination of DL, UL and FL OFDM symbols. The possible slot formats are summarized in the table of FIG. 4, which is reproduced from [5]. The GC-DCI carrying the SFI has a monitoring periodicity of P_{SFI} where the slot format indicated in the SFI is applicable for all slots within P_{SFI}; and
DCI carrying Dynamic Grants: The dynamic grants, e.g. DL Grant or UL Grant, do not specifically indicate the slot format, but can schedule a UE with a DL transmission or an UL transmission overlapping FL symbols, and this implicitly tells the UE that these FL symbols are used for DL or UL.

A UE is not expected to be given contradictory slot format configurations by the above four slot format configurations. To avoid contradictory slot formats, an order of precedence is followed—in the order the configurations are described above—where for example the Cell Common semi-static slot format has a higher precedence over the UE specific semi-static slot format, such that symbols configured as DL or UL in the Cell Common semi-static slot format cannot be changed by the UE specific semi-static slot format. Only FL symbols configured by the Cell Common semi-static slot format can be changed to DL or UL symbols (or indeed remain as FL symbols) by the UE specific semi-static slot format. The resultant slot format as a combination of Cell Common semi-static slot format and UE specific slot format is referred to as a semi-static slot format, and therefore the resultant OFDM symbol format due to the combination of Cell Common semi-static slot format and UE specific semi-static slot format configurations can be referred to as “semi-static DL symbols”, “semi-static UL symbols” and “semi-static FL symbols”.

RRC or semi-static slot format configurations have precedence over dynamic slot format configurations. That is, semi-static DL symbol and semi-static UL symbol cannot be changed by SFI but only semi-static FL symbol can be changed by SFI to be either DL, UL or remain as FL. Similarly SFI has higher precedence over Dynamic Grants, that is the Dynamic Grants cannot implicitly change a semi-static DL symbol, semi-static UL symbol and semi-static FL symbol that has been indicated by the SFI as DL or UL.

FIG. 5 schematically represents a grid of radio communication resources which can be used for communications between a communications device and a wireless communications network. The slot format configuration for each of slots n, n+1, n+2, n+3 and n+4 shown in FIG. 5 is represented by the arrangement of OFDM symbols. As explained briefly above, each OFDM symbol can be configured semi-statically (RRC configured) to be Downlink (DL), Uplink (UL) or Flexible (F-symbol, or FL symbols). For example, in FIG. 5, the OFDM symbols in slot n are downlink symbols, the OFDM symbols in slot n+2 are flexible symbols and the OFDM symbols in slot n+3 are uplink symbols. It is possible, as shown in slot n+1 of FIG. 5, for different OFDM symbols within a slot to have different configurations. For example, in slot n+1, the first seven OFDM symbols in slot n+1 are downlink symbols whereas the second seven symbols in slot n+1 are uplink symbols. When an OFDM symbol is labelled as DL, a communications device can only receive DL channels/signals on the corresponding PRBs (i.e. subcarriers) in the frequency domain. Similarly, when an OFDM symbol is labelled as UL, a communications device can only transmit UL channels/signals on the corresponding PRBs in frequency domain. This means that communications devices in the same cell cannot transmit and receive at the same time for the same OFDM symbol that is semi-statically configured or indicated by the SFI for one direction, i.e. either DL or UL. This restriction contributes to the reduction of communications device complexity and power saving.

As will be appreciated by one skilled in the art, the F-symbol can be dynamically configured using SFI (Slot Format Indicator) to be DL or UL or remain as Flexible. The SFI is included in a Group Common DCI (Format 2_0) that is signaled to multiple communications devices to indicate the slot format of one or more slots. Currently, there are 255 possible slot formats (as shown in FIG. 4). In other words, there are 225 different possible combinations of DL-symbols, UL-symbols and F-symbols currently configurable in a slot. The SFI is RRC configured with Slot Format Combination which is a subset of the 255 possible slot formats. In other words, the wireless communications network selects a subset of slot formats that can be dynamically indicated in the SFI. Each subset of Slot Formats in the Slot Format Combination is assigned a Slot Format Combination ID and the SFI signals this Slot Format Combination ID to the group of communications devices. If the F-symbols are not indicated as UL-symbols or DL-symbols, the UL Grant or the DL Grant would implicitly assign them as UL-symbols or DL-symbols if the scheduled PUSCH or PDSCH occupies these F-symbols (FL).

### BWP Slot Format

In the current NR systems, a system bandwidth may be divided into one or more frequency domain portions or parts known as bandwidth parts (BWPs). The system bandwidth may be alternatively referred to as the “carrier bandwidth”. As will be appreciated by one skilled in the art, a BWP is a set of contiguous resource blocks inside the system bandwidth. The width in frequency domain of a BWP is therefore equal to or less than the system bandwidth. Currently, a communications device, or UE, inside a serving cell may be configured with up to four BWPs for communications with infrastructure equipment which provides the serving cell. However, only one such BWP may be active for a particular communications device at a given time. The use of BWPs may reduce power consumption in communications devices because communications devices configured with one or more BWPs may only be required to receive and decode signals up to a frequency width of the BWP configured for the communications device rather than the entire system bandwidth.

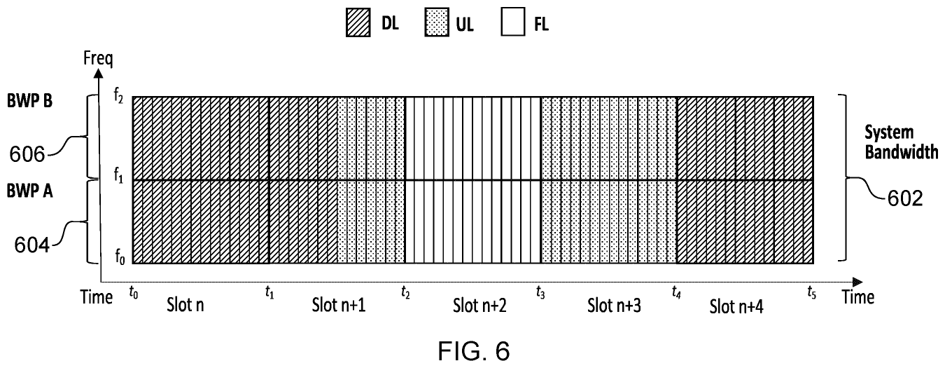

FIG. 6 schematically represents a grid of radio communications resources where communications resources are divided into two frequency domain portions or bandwidth parts for one or more communications devices. As shown in FIG. 6, one or more communications devices are configured with two bandwidth parts 604, 606 inside a system bandwidth 602. Specially, the system bandwidth 602 spanning from f0 to f2 comprises a first bandwidth part BWP A 604 spanning from f0 to f1 and a second bandwidth part BWP B 606 spanning from f1 to f2. Although only two bandwidth parts are shown in FIG. 6 for simplicity, a communications device may be configured with more than two bandwidth parts as explained above. Although the first BWP A 604 and second BWP 606 bandwidth parts are shown as being contiguous in frequency in FIG. 6, it will be appreciated that a frequency gap may separate the first BWP A 604 and second BWP 606 bandwidth parts. In FIG. 6, the first BWP A 604 and second BWP 606 bandwidth parts have the same slot format configuration for each of slots n to slot n+4. In other words, the first BWP A 604 and second BWP 606 bandwidth parts have the same arrangement of OFDM symbols in each of slots n to slot n+4. For example, the OFDM symbols in slot n for both the first BWP A 604 and second BWP B 606 bandwidth parts are downlink symbols, whereas the OFDM symbols in slot n+3 for the first BWP A 604 and second BWP B 606 bandwidth parts are uplink symbols. According to conventional arrangements, if an OFDM symbols is configured as being uplink, downlink or flexible for one BWP then the OFDM symbol occurring at the corresponding time for another BWP which forms part of the same system bandwidth must have the same configuration. For example, it is not possible for any of the OFDM symbols in slot n for the second bandwidth part BWP B 606 to be anything other than downlink symbols because the OFDM symbols in slot n for the first bandwidth part BWP A 604 are downlink symbols.

It is envisaged that the above-described inflexibility in conventional slot format configurations will lead to technical problems in the efficient implementation of full duplex TDD (FD-TDD) operation for both communications devices and infrastructure equipment as will be explained in more detail with reference to the following examples: In one example, a communication device communicating with an infrastructure equipment (such as a gNB or eNB) may be operating according to a HD-FDD operation whereas the infrastructure equipment may be operating according to a FD-TDD mode of operation. Therefore, the infrastructure equipment can transmit or receive signals from one or more communications devices in its coverage area at the same time. It may be desirable in one such implementation for the infrastructure equipment to simultaneously receive uplink signals from a first communications device in slot n using one BWP, and transmit downlink signals to another communications device in slot n using another BWP. In another example, the communications device and the infrastructure equipment may be configured to operate according to a FD-HDD mode of operation. In this operation, it may be desired for the communications device to simultaneously transmit uplink signals in slot n using one BWP and simultaneously receive downlink signals using another BWP. However, as explained above with reference to FIG. 6, if the OFDM symbols in slot n for the first bandwidth part BWP A 604 are configured as downlink symbols then the corresponding OFDM symbols in slot n for the second bandwidth part BWP B 606 must also be configured as downlink symbols according to conventional arrangements. The above FD-TDD scenarios cannot therefore be accommodated according to conventional arrangements.

It will therefore be appreciated that legacy slot format configurations impose limitations for communications devices or infrastructure equipment operating according to an FD-TDD mode of operation. Although it is possible for an infrastructure equipment to configure a communications device to contain only flexible symbols, which may subsequently be dynamically configured as either uplink or downlink symbols, this proposal creates difficulties with preserving backwards compatibility. For example, as explained above, communications devices which are capable of using an FD-TDD mode of operation are expected to have an increased hardware complexity. However, there may exist other, legacy communications devices in the same cell which are not capable of using an FD-TDD mode of operation. Such legacy communications devices may require to receive some channels or signals in a backward compatible manner, such as PRACH, SSB configurations and DL PDCCH for scheduling. Therefore, the wireless communications network must configure the slots containing those signals as being uplink or downlink (but not flexible) due to the legacy communications devices. In other words, to preserve the backwards compatibility of legacy communications devices, the legacy slot format configuration for at least some of the slots should remain in the format initially configured by the wireless communications network.

Furthermore, frequently changing slot format combinations for TDD operation may lead to dimensioning for capacity and coverage. In other words, it is typically difficult for a TDD wireless communications network operator to re-configure the slot format of the entire wireless communications network in order to support FD-TDD without disrupting legacy operations.

Therefore, technical problems arise for enabling flexible scheduling for FD-TDD operations in such a manner that the legacy operations are not impacted.

In view of the above, there is provided a method of operating a communications device configured to receive signals from a wireless communications network via a wireless access interface provided by the wireless communications network. The communications device receives a frequency resource indicator indicating to the communications device to configure a first frequency domain portion of communications resources of the wireless access interface which can be used for communications between the communications device and the wireless communications network. In some embodiments, the first frequency domain portion of the communications resources may be a bandwidth part of the communications resources.

The frequency resource indicator indicates a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources. Configurations of communications resources may be represented by a pattern or arrangement of time and frequency resources such as physical resource blocks or any other resource unit known to one skilled in the art. In a particular example, the configuration of first frequency domain portion of the communications resources may be represented by an arrangement of OFDM symbols in a plurality of slots associated with a bandwidth part, and whether such OFDM symbols are uplink, downlink or flexible signals. The configuration of communications resources may therefore alternatively be referred to as a slot format configuration. Flexible communications resources may be subsequently configured as uplink or downlink communications resources by any means known to one skilled in the art such as by dynamic configuration, for example dynamic grant or SFI.

In response to receiving the frequency resource indicator, the communications device configures the first frequency domain portion of the communications resources in accordance with the configuration indicated by the frequency resource indicator. For example, the communications device may configure communications resources in the first frequency domain portion as uplink, downlink or flexible communications resources depending on the configuration that was indicated in the frequency resource indicator.

The configuration of the first frequency domain portion of the communications resources is different from a configuration of another, second frequency portion of the communications resources. In some embodiments, the second frequency portion is another bandwidth part of the communications resources which can be used by the communications device to communicate with the wireless communications network. In other words, the first frequency domain portion of the communications resources may have a different slot format configuration compared with a slot format configuration for the second frequency domain portion of the communications resources. In some embodiments, the second frequency domain portion may have a legacy slot format configuration whereas the first frequency domain portion is configured with an updated slot format configuration after it receives the frequency resource indicator. In some embodiments, the first and/or second frequency domain portions may have been previously configured (such as semi statically configured for example). In such cases, the indication in the frequency resource indicator to the communications device to configure the first frequency domain portion is an indication to reconfigure the first frequency domain portion. In other words, the frequency resource indicator may allow for previously configured communications resources in the first frequency domain portion to be overwritten.

As explained above, the frequency resource indicator may be used as an overwrite indicator that overwrites previously configured communication resources. That is, the frequency resource indicator indicates that at least a portion of the communications resources previously configured as uplink communications resources reserved for uplink transmissions should be re-configured as downlink communications resources reserved for downlink transmissions or flexible communications resources which can be subsequently configured as uplink or downlink communications resources, and/or the frequency resource indicator includes an indication that at least a portion of the communications resources previously configured as downlink communications resources should be configured or re-configured as uplink or flexible communications resources.

After the configuration of the first frequency domain portion of the communications resources, the communications device may transmit uplink transmissions on configured uplink communications resources in the first frequency domain portion and/or receive downlink transmissions on configured downlink communications resources in the first frequency domain portion.

### Updated Slot Format Configuration

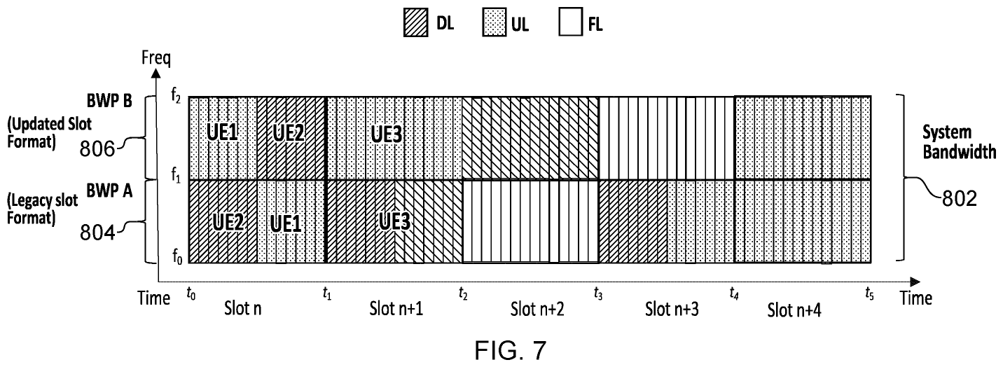

FIG. 7 illustrates a grid of communications resources with a legacy slot format for one bandwidth part and a grid of communications resources with an updated slot format for another bandwidth part in accordance with example embodiments. The grid of communications resources with the legacy slot format are an example of “previously configured” communications resources whereas the grid of communications resources with the updated slot format are an example of the communications resources with the “updated configuration”. In particular, FIG. 7 schematically illustrates a slot format configuration for slots n to n+4 for a first bandwidth part BWP A 804 and a second bandwidth part BWP B 806. As shown in FIG. 7, a first communications device (UE1), a second communications device (UE2) and a third communications device (UE3) are configured with the first bandwidth part BWP A 804 and the second bandwidth part BWP B 806. The first bandwidth part BWP A 804 and the second bandwidth part BWP B 806 form part of a system bandwidth 802. Although each of the communications devices are configured with two BWPs 804, 806 in FIG. 7, it will be appreciated that each communications device UE1, UE2, UE3 may be configured with more than two BWPs as explained above. Additionally, although the BWPs 804, 806 in FIG. 7 are shown as being contiguous in frequency, it will be appreciated that a frequency gap may separate the first bandwidth part BWP A 804 and the second bandwidth part BWP B 806. In accordance with example embodiments, a slot format configuration of one or more slots for the first bandwidth part may be different from the slot format of one or more slots for the second bandwidth part. In FIG. 7, for example, the slot format of each of slots n to slot n+3 is different for the first bandwidth part BWP A 804 and the second bandwidth part BWP B 806. In this example, the first bandwidth part BWP A 804 has a legacy slot format configuration. In other words, the slot format configuration for the first bandwidth part BWP A 804 may have been configured using cell-common semi static slot format, UE specific semi-static slot format, a slot format indicator, or a DCI as explained above. Therefore, according to conventional/legacy systems, the slot format for each of slots n to slot n+4 are restricted, that is, they should be the same for the first bandwidth part BWP A 804 and the second bandwidth part BWP B 806. According to example embodiments, as will be explained in more detail below with reference to FIG. 7, a bandwidth part which is previously restricted or configured with a legacy slot format configuration may overwrite the restriction in the legacy slot format configuration to form an updated slot format configuration.

For example, in slot n, the legacy slot format configuration is used for the first bandwidth part BWP A 804 where the first seven symbols are DL symbols, and the second seven symbols are UL symbols. However, for the second bandwidth part BWP B 806, in slot n, a new or updated slot format configuration is introduced. As is visible from FIG. 7, the legacy slot format configuration for the second bandwidth part BWP B 806 has been overwritten with the first seven symbols being overwritten from DL to UL symbols and the second seven symbols being overwritten from UL to DL symbols.

In slot n+1, the legacy slot format configuration is used for the first bandwidth part BWP A 804 where all the symbols in that slot are DL symbols. However, for the second bandwidth part BWP B 806, in slot n+1, a new slot format configuration is introduced where all the symbols in in slot n+1 are overwritten from DL to UL symbols.

In slot n+2, the legacy slot format configuration is used for the first bandwidth part BWP A 804 where all the symbols in that slot are FL symbols. However, for the second bandwidth part BWP B 806, in slot n+2, a new slot format configuration is introduced where the all the symbols in slot n+2 are overwritten from FL to DL symbols.

In slot n+3, the legacy slot format configuration is used for the first bandwidth part BWP A 804 where the first seven symbols are DL symbols, and the second seven symbols are UL symbols. However, for the second bandwidth part BWP B 806, in slot n+3, a new slot format configuration is introduced where all the symbols are overwritten from DL to FL symbols.

In slot n+4, the legacy slot format configuration is used for both the first bandwidth part BWP A 804 and the second bandwidth part BWP B 806. In other words, the symbols in slot n+4 are UL symbols for both the first bandwidth part BWP A 804 and the second bandwidth part BWP B 806.

As explained above, the restriction in conventional systems that the slot format configuration must be the same across the entire system bandwidth is overcome by overwriting previously restricted slot formats in a frequency portion, represented here as a BWP.

In one example, shown in slot n of FIG. 7, an infrastructure equipment (such as a gNB) may schedule the second communications device UE2 to receive downlink transmissions on the first bandwidth part BWP A 804 in the first seven symbols of slot n and schedule the first communications device UE1 to transmit uplink transmissions on the second bandwidth part BWP B 806 in the first seven symbols of slot n. Therefore, if the gNB is configured to use FD-TDD operation, the gNB may simultaneously receive uplink transmissions from the first communications device UE1 and transmit downlink transmissions to the second communications device UE2.

In another example, also shown in slot n of FIG. 7, the gNB may schedule the second communications device UE2 to receive downlink transmissions on the second bandwidth part BWP B 806 in the second seven symbols of slot n and schedule the first communications device UE1 to transmit uplink transmissions on the first bandwidth part BWP A 804 in the second seven symbols of slot n. Therefore, if the gNB is configured to use FD-TDD operation, the gNB may simultaneously receive uplink transmissions from the first communications device UE1 and transmit downlink transmissions to the second communications device UE2.

In another example, shown in slot n+1 of FIG. 7, the gNB may schedule a third communications device UE3 to receive downlink transmissions on the first bandwidth part BWP A 804 and to simultaneously transmit uplink transmissions in the second bandwidth part BWP B 806 in slot n+1. Therefore, if the third communications device UE3 and the gNB are configured to use FD-TDD operation, then the gNB may simultaneously receive uplink transmissions from the third communications device UE3 and transmit downlink transmissions to the third communications device UE3 in slot n+1.

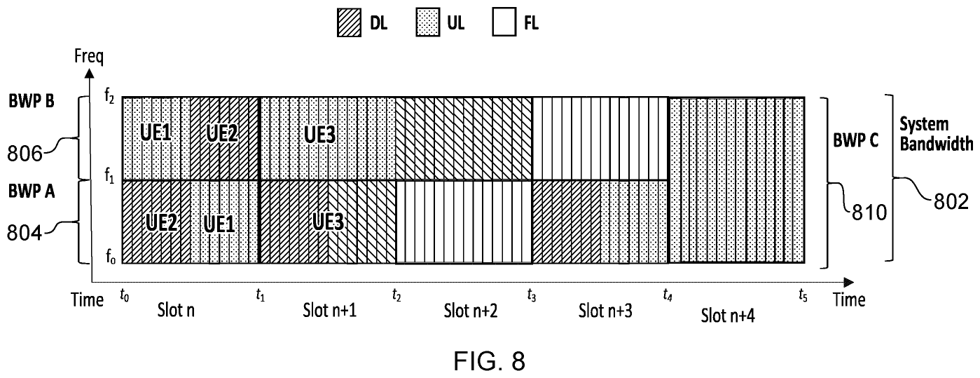

FIG. 8 is based on FIG. 7 but additionally illustrates the combination of bandwidth parts according to example embodiments. As explained above with reference to FIG. 7, the slot format configuration is updated for the second bandwidth part BWP B 806. However, the updated slot format configuration may have one or more symbols with the same format as for the legacy slot format configuration. For example, as shown in slot n+4 in FIG. 7, uplink symbols are configured for both the first bandwidth part BWP A 804 and the second bandwidth part BWP B 806. In accordance with example embodiments, a communications device may be scheduled by an infrastructure equipment such as a gNB to combine two or more BWPs for one or more symbols which have the same format to create a BWP with a larger frequency range. For example, in FIG. 8, one of the three communications devices UE1, UE2 or UE3 may be scheduled to combine the first bandwidth part BWP A 804 and the second bandwidth part BWP B 806 into a third bandwidth part BWP C 810 in slot n+4. The third bandwidth part BWP C 810 spans the frequency range f0 to f2. In some embodiments, different bandwidth parts may be combined over one or more symbols even if the symbols do not have the same format. For example, if one or more symbols for one bandwidth part are uplink or downlink symbols, and one or more symbols occurring at a corresponding point in time for another bandwidth part are flexible symbols, then the bandwidth parts may be combined for the duration of the one or more symbols. As will be appreciated, the combination of two or more bandwidth parts into another bandwidth part with a wider frequency range is particularly advantageous in scenarios in which the communications device has a large amount of data to transmit or receive.

In another example, bandwidth part BWP C which includes or overlaps other BWPs can have separate slot formats configuration where each slot format contains uplink and or downlink and or flexible symbols.

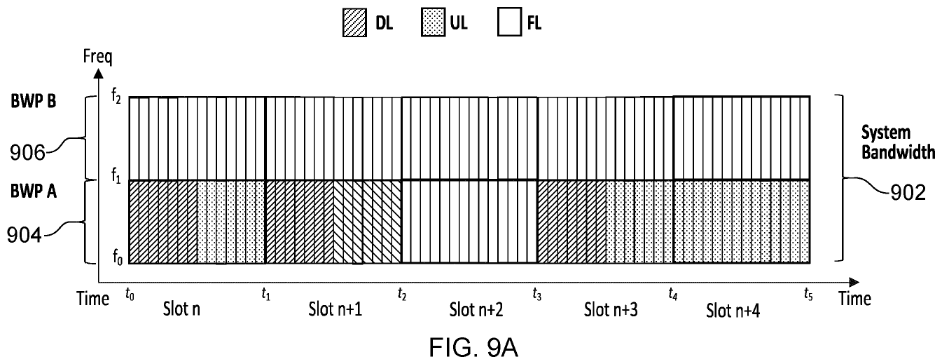

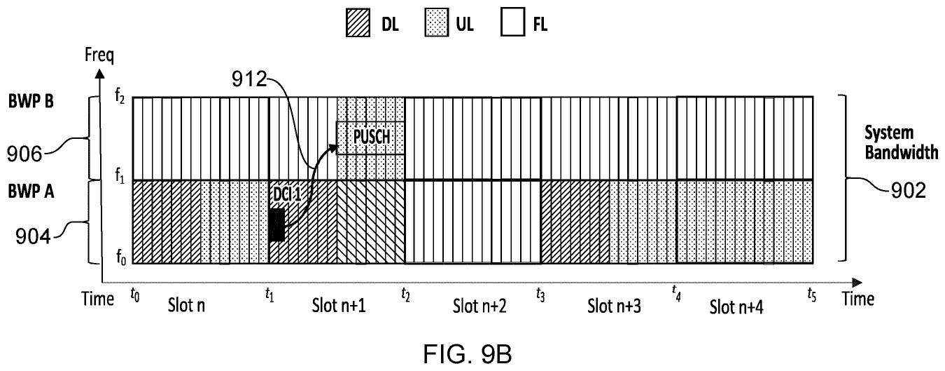

FIG. 9A is based on FIG. 7 but additionally illustrates an updated slot format configuration with only flexible symbols according to example embodiments. In some example embodiments, the updated slot format configuration may comprise only flexible symbols or slots containing flexible symbols as illustrated in FIG. 9A. In other words, the legacy slot format may be overwritten so that symbols which were previously configured as uplink or downlink symbols are configured as flexible symbols. For example, a second bandwidth part BWP B 906 is illustrated in FIG. 9A which has an updated slot format configuration with only flexible symbols. As explained above, a flexible symbol is a placeholder which can be used subsequently for either uplink or downlink transmissions as required.

In some embodiments, a communications device may overwrite a legacy slot format configuration to form an updated slot format configuration with only flexible signals in response to broadcast or UE-specific signalling in a cell containing the communications device. Subsequently, the communications may receive signalling (such as a scheduling grant or DCI) which overwrites flexible symbols forming part of the updated slot configuration. For example, as shown in FIG. 9B, the communications device may receive DCI 1 on a first bandwidth part BWP A 904 which schedules a corresponding Physical Uplink Shared Channel (PUSCH) transmission in the second seven flexible symbols of slot n+1 on the second bandwidth part BWP B 906 as represented by arrow 912. Accordingly, as the PUSCH is an uplink transmission, the communications device changes the second seven symbols of slot n+1 in which the PUSCH is scheduled from flexible symbols to uplink symbols for the PUSCH transmission.

Although the above examples described that the first bandwidth part BWP A 804, 904 has a legacy slot format configuration, and the communications device overwrites the legacy slot format configuration for the second bandwidth part BWP B 806, 906 to form an updated slot format configuration, it will be appreciated that, in other examples, the second bandwidth part BWP B 806 has a legacy slot format configuration and the communications device overwrites the legacy slot format configuration for the first bandwidth part BWP A 804 to form the updated slot format configuration. In other examples, the communications device may be configured with BWPs that are not restricted, that is, the communications device may not be configured with a legacy BWP and here the overwriting aspect is the overwriting of the Cell Common slot format configuration.

### Signalling of the Updated Slot Format Configuration

As described above, a bandwidth part may be provided with an updated slot format configuration different from a legacy slot format configuration for other bandwidth parts. In accordance with example embodiments, a communications device receives a frequency resource indicator from the wireless communications network which indicates to the communications device to configure a first frequency domain portion of communications resources such as a bandwidth part which has a different configuration than another, second frequency domain portion of the communications resources. In some examples, the frequency resource indicator indicates to the communications device to overwrite a legacy slot format configuration to form an updated slot format configuration.

According to example embodiments, the frequency resource indicator may be received by the communications device in RRC signals from the wireless communications network. For example, the indication of the updated slot format configuration may denote slot formats for a portion of frequency domain resources. The arrangement of UL, DL and FL symbols in a slot may be explicitly configured independently for each slot in a radio frame. The frequency resource indicator may indicate slot format combinations where a number of slot formats are combined to make slot format combination for a communications device. In some embodiments, flexible symbols indicated in the updated slot format configuration may be subsequently changed to uplink or downlink symbols by DCI or SFI. Each BWP may be identified by the communications device and the wireless communications network using an ID or an index.

According to example embodiments, the frequency resource indicator may be received by the communications device in an SFI from the wireless communications network. For example, the SFI may overwrite slot formats for each BWP for a period of time (up to N slots or duration of the SFI) for a group of communications devices. For example, a communications device may receive a single SFI containing two indicators, one for BWP A and another for BWP B. In some embodiments, a communications device receives two separate SFIs in different times where each SFI has a different RNTI.

According to example embodiments, the frequency resource indicator may be received by the communications device in a dynamic grant from the wireless communications network. In some embodiments, a DCI from the wireless communications network may schedule to the overwritten BWP and at the same time activates the same BWP. The frequency resource indicator may be the DCI itself without any additional bits as the DCI already indicates whether it is for DL or UL scheduling. The DCI contains a BWP index which identifies the scheduled and activated BWP. The signalling indicator could also be 1-bit in the DCI indicating to change any symbols that are different than the direction of the scheduling DCI (DL or UL). These symbols can be identified from resource allocation fields of frequency domain and time-domain resource allocations. The frequency domain resource field indicates a number of PRBs allocated in frequency domain within a BWP while time domain resource field denotes a number of OFDM symbols allocated in a slot, hence resulting two dimensional allocations.

In some embodiments, the frequency resource indicator is received in one or more Medium Access Control, MAC, Control Element, CE, signals from the wireless communications network.

In some embodiments, only RRC signaling is allowed to overwrite or change the DL to UL or UL to DL, whereas the SFI and DCI are used to change F-symbols to either DL or UL symbols. In an example the RRC signalling is in the SIB-1 where new parameters (e.g. as extension) in this SIB-1 can be read by new UE (e.g. Rel-18 onwards) and can therefore apply slot format that overwrites the restriction in the legacy operation. The legacy UE can ignore these new parameters. In another example, the RRC signalling is UE specific, that is, each UE can be configured with multiple BWPs that does not follow the restriction imposed on legacy operation, such as some of these BWPs can have opposing transmission direction at the same time.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured to receive signals from a wireless communications network via a wireless access interface provided by the wireless communications network, the method comprising
receiving, by the communications device, a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, and in response the method comprises
configuring, by the communications device, the first frequency domain portion of the communications resources in accordance with the configuration indicated by the frequency resource indicator, wherein the configuration of the first frequency domain portion of the communications resources is different from a configuration of another, second frequency portion of the communications resources.

Paragraph 2. A method according to paragraph 1, wherein the configuring the first frequency domain portion of the communications resources in accordance with the configuration indicated by the communications resource indicator comprises
reconfiguring communications resources in the first frequency domain portion of the communications resources previously configured as uplink communications resources as downlink or flexible communications resources, or
   reconfiguring communications resources in the first frequency domain portion of the communications resources previously configured as downlink communications resources as uplink or flexible communications resources.

Paragraph 3. A method according to paragraph 1 or 2, wherein the second frequency domain portion has been previously configured and the frequency resource indicator includes an indication that the second frequency domain portion of the communications resources should not be re-configured by the communications device.

Paragraph 4. A method according to paragraph 1 or 2, wherein the frequency domain indicator indicates to the communications device to configure the second frequency domain portion of the communications resources, and the frequency resource indicator indicates the configuration of the second frequency domain portion indicating whether communications resources in the second frequency domain portion should be configured as uplink, downlink or flexible resources.

Paragraph 5. A method according to any of paragraphs 1 to 4, wherein the communications resources which can be used for communications between the communications device and the wireless communications network are divided in frequency into a plurality of bandwidth parts, the first frequency domain portion of the communications resources being one of the bandwidth parts as a first bandwidth part and the second frequency domain portion of the communications resources being another, different one of the bandwidth parts as a second bandwidth part.

Paragraph 6. A method according to paragraph 5, wherein the first and second bandwidth parts are each formed from a plurality of Orthogonal Frequency Division Multiplexing, OFDM, symbols, wherein the indication of the configuration of the first frequency domain portion including whether communications resources in the first frequency domain portion should be configured as uplink, downlink or flexible communications resources comprises

an indication of whether OFDM symbols in the first bandwidth part should be configured as uplink symbols reserved for uplink transmissions, downlink symbols reserved for downlink transmissions or flexible symbols which can be subsequently configured as either uplink or downlink symbols, and the configuring the first frequency domain portion in accordance with the configuration indicated by the frequency resource indicator comprises
configuring one or more OFDM symbols in the first bandwidth part in accordance with the configuration indicated by the frequency resource indicator.

Paragraph 7. A method according to paragraph 6, comprising
determining, by the communications device, that one or more of the OFDM symbols for the first bandwidth part and the second bandwidth part overlap in time,
determining that the overlapping OFDM symbols are both uplink symbols, or both downlink symbols, or both flexible symbols, or one of the OFDM symbols is a flexible symbol and the other of the overlapping OFDM symbols is an uplink or a downlink symbol,
combining the overlapping OFDM symbols to form a third bandwidth part with a larger frequency range than the first or second bandwidth parts.

Paragraph 8. A method according to paragraph 6 or 7, wherein the indication of whether OFDM symbols in the first bandwidth part should be configured as uplink symbols reserved for uplink transmissions, downlink transmission reserved for downlink transmissions or flexible symbols which can be subsequently configured as either uplink or downlink symbols comprises
an indication that one or more of the OFDM symbols for the first bandwidth part should be configured as flexible symbols.

Paragraph 9. A method according to paragraph 8, comprising
receiving, by the communications device from the wireless communications network, an indicator scheduling an uplink or a downlink transmission on the one or more flexible symbols, and in response,
determining, by the communications device, that the one or more flexible symbols are uplink or downlink symbols respectively, and
transmitting the scheduled uplink transmission on the uplink symbols, or
receiving the scheduled downlink transmission on the downlink symbols.

Paragraph 10. A method according to paragraph 9, wherein the receiving the indicator scheduling an uplink or a downlink transmission on the one or more flexible symbols comprises
receiving a downlink control indicator, DCI, scheduling a downlink transmission on the one or more flexible symbols, and in response,
activating, by the communications device, the first bandwidth part for the scheduled downlink transmission, and the determining that the one or more flexible symbols are uplink or downlink OFDM symbols respectively comprises
determining that the one or more flexible symbols are downlink symbols, and
transmitting the scheduled downlink transmission on the downlink symbols.

Paragraph 11. A method according to any of paragraphs 1 to 10, wherein the frequency resource indicator is received in one or more Radio Resource Control, RRC, signals from the wireless communications network.

Paragraph 12. A method according to any of paragraphs 1 to 10, wherein the frequency resource indicator is received in one or more Slot Format Indicator, SFI, signals from the wireless communications network.

Paragraph 13. A method according to paragraph 12, wherein each of the one or more SFI indicator signals indicate to the communications device to configure one or more frequency portions the communications resources each corresponding to a different bandwidth part.

Paragraph 14. A method according to paragraph 12 or 13, wherein the one or more SFI indicator signals indicate to the communications device to configure one or more frequency domain portions of the communications resources each corresponding to a different bandwidth part for a pre-defined time duration.

Paragraph 15. A method according to any of paragraphs 1 to 10, wherein the frequency resource indicator is received in one or more Medium Access Control, MAC, Control Element, CE, signals from the wireless communications network.

Paragraph 16. A method according to any of paragraphs 1 to 15, comprising
receiving, by the communications device, an indication of a previous configuration of the first frequency domain portion of the communications resources from the wireless communications network including an indication of whether communications resources in the first frequency domain portion are configured as uplink, downlink or flexible communications resources.

Paragraph 17. A method according to paragraph 16, wherein the previous configuration of the first frequency domain portion of the communications resources received from the wireless communications network is semi-statically configured by the wireless communications network.

Paragraph 18. A method according to paragraph 17, wherein the previous configuration of the first frequency domain portion of the communications resources received from the wireless communications network is a cell common semi-static slot format received in a system information block from the wireless communications network.

Paragraph 19. A method according to paragraph 17, wherein the previous configuration of the first frequency domain portion of the communications resources received from the wireless communications network is a communications device-specific semi-static slot format received in one or more Radio Resource Control, RRC, signals from the wireless communications network.

Paragraph 20. A method according to paragraph 16, wherein the previous configuration of the first frequency domain portion of the communications resources received from the wireless communications network is indicated by the wireless communications network in a Slot Format Indicator, SFI.

Paragraph 21. A method according to paragraph 16, wherein the previous configuration of the first frequency domain portion of the communications resources received from the wireless communications network is indicated by a downlink or uplink dynamic grant contained in Downlink Control Information, DCI, received from the wireless communications network.

Paragraph 22. A method according to any of paragraphs 16 to 21, wherein the previous configuration of the first frequency domain portion of the communications resources is the same as the configuration of the second frequency domain portion of the communications resources.

Paragraph 23. A method of operating an infrastructure equipment of a wireless communications network configured to transmit signals to a communications device via a wireless access interface provided by the wireless communications network, the method comprising
transmitting, by the infrastructure equipment, a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, wherein the configuration of the first frequency domain portion of the communications resources is different from a configuration of another, second frequency portion of the communications resources.

Paragraph 24. A method according to paragraph 23, wherein the second frequency domain portion has been previously configured and the frequency resource indicator includes an indication that the second frequency domain portion of the communications resources should not be re-configured by the communications device.

Paragraph 25. A method according to paragraph 23 or 24, wherein the frequency domain indicator indicates to the communications device to configure the second frequency domain portion of the communications resources, and the frequency resource indicator indicates the configuration of the second frequency domain portion indicating whether communications resources in the second frequency domain portion should be configured as uplink, downlink or flexible resources.

Paragraph 26. A method according to any of paragraphs 23 to paragraph 25, wherein the communications resources which can be used for communications between the communications device and the wireless communications network are divided in frequency into a plurality of bandwidth parts, the first frequency domain portion of the communications resources being one of the bandwidth parts as a first bandwidth part and the second frequency domain portion of the communications resources being another, different one of the bandwidth parts as a second bandwidth part.

Paragraph 27. A method according to paragraph 26, wherein the first and second bandwidth parts are each formed from a plurality of Orthogonal Frequency Division Multiplexing, OFDM, symbols, wherein the indication of the configuration of the first frequency domain portion including whether communications resources in the first frequency domain portion should be configured as uplink, downlink or flexible communications resources comprises an indication of whether OFDM symbols in the first bandwidth part should be configured as uplink symbols reserved for uplink transmissions, downlink symbols reserved for downlink transmissions or flexible symbols which can be subsequently configured as either uplink or downlink symbols.

Paragraph 28. A method according to 27, wherein the indication of whether OFDM symbols in the first bandwidth part should be configured as uplink symbols reserved for uplink transmissions, downlink transmission reserved for downlink transmissions or flexible symbols which can be subsequently configured as either uplink or downlink symbols comprises
an indication that one or more of the OFDM symbols for the first bandwidth part should be configured as flexible symbols.

Paragraph 29. A method according to paragraph 28, comprising
transmitting, to the communications device, an indicator scheduling an uplink or a downlink transmission on the one or more flexible symbols, and
receiving the scheduled uplink transmission on the flexible symbols, or
transmitting the scheduled downlink transmission on the flexible symbols.

Paragraph 30. A method according to paragraph 29, wherein the transmitting the indicator scheduling an uplink or a downlink transmission on the one or more flexible symbols comprises
transmitting a downlink control indicator, DCI, scheduling a downlink transmission on the one or more flexible symbols, and
receiving the scheduled downlink transmission on the flexible symbols.

Paragraph 31. A method according to any of paragraphs 23 to 30, wherein the frequency resource indicator is transmitted in in one or more Radio Resource Control, RRC, signals.

Paragraph 32. A method according to any of paragraphs 23 to 31, wherein the frequency resource indicator is transmitted in in one or more Slot Format Indicator, SFI, signals.

Paragraph 33. A method according to paragraph 32, wherein each of the one or more SFI indicator signals indicate to the communications device to configure one or more frequency portions the communications resources each corresponding to a different bandwidth part.

Paragraph 34. A method according to paragraph 32 or 33, wherein the one or more SFI indicator signals indicate to the communications device to configure one or more frequency domain portions of the communications resources each corresponding to a different bandwidth part for a pre-defined time duration.

Paragraph 35. A method according to any of paragraphs 23 to 30, wherein the frequency resource indicator is transmitted in one or more Medium Access Control, MAC, Control Element, CE, signals.

Paragraph 36. A method according to any of paragraphs 23 to 35, comprising
transmitting, by the communications device, an indication of a previous configuration of the first frequency domain portion of the communications resources including an indication of whether communications resources in the first frequency domain portion are configured as uplink, downlink or flexible communications resources.

Paragraph 37. A method according to paragraph 36, wherein the previous configuration of the first frequency domain portion of the communications resources transmitted semi-statically.

Paragraph 38. A method according to paragraph 37, wherein the previous configuration of the first frequency domain portion of the communications resources is a cell common semi-static slot format transmitted in a system information block.

Paragraph 39. A method according to paragraph 37, wherein the previous configuration of the first frequency domain portion of the communications resources is a communications device-specific semi-static slot format transmitted in one or more Radio Resource Control, RRC.

Paragraph 40. A method according to paragraph 36, wherein the previous configuration of the first frequency domain portion of the communications resources transmitted by the infrastructure equipment in a Slot Format Indicator, SFI.

Paragraph 41. A method according to paragraph 36, wherein the previous configuration of the first frequency domain portion of the communications resources is indicated by a downlink or uplink dynamic grant contained in Downlink Control Information, DCI, transmitted by the infrastructure equipment.

Paragraph 42. A method according to any of paragraphs 36 to 41, wherein the previous configuration of the first frequency domain portion of the communications resources is the same as the configuration of the second frequency domain portion of the communications resources.

Paragraph 43. A communications device configured to receive signals from a wireless communications network via a wireless access interface provided by the wireless communications network, the communications device comprising
transceiver circuitry configured to transmit and/or to receive signals,
control circuitry configured in combination with the transceiver circuitry to
receive a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, and in response the control circuitry is configured in combination with the transceiver circuitry to
configure the first frequency domain portion of the communications resources in accordance with the configuration indicated by the frequency resource indicator, wherein the configuration of the first frequency domain portion of the communications resources is different from a configuration of another, second frequency portion of the communications resources.

Paragraph 44. Circuitry for a communications device configured to receive signals from a wireless communications network via a wireless access interface provided by the wireless communications network, the circuitry comprising
transceiver circuitry configured to transmit and/or to receive signals,
control circuitry configured in combination with the transceiver circuitry to
receive a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, and in response the control circuitry is configured in combination with the transceiver circuitry to
configure the first frequency domain portion of the communications resources in accordance with the configuration indicated by the frequency resource indicator, wherein the configuration of the first frequency domain portion of the communications resources is different from a configuration of another, second frequency portion of the communications resources.

Paragraph 45. An infrastructure equipment of a wireless communications network configured to transmit signals to a communications device via a wireless access interface provided by the wireless communications network, the infrastructure equipment comprising
transceiver circuitry configured to transmit and/or to receive signals;
control circuitry configured in combination with the transceiver circuitry to
transmit a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, wherein the configuration of the first frequency domain portion of the communications resources is different from a configuration of another, second frequency portion of the communications resources.

Paragraph 46. Circuitry for an infrastructure equipment of a wireless communications network configured to transmit signals to a communications device via a wireless access interface provided by the wireless communications network, the circuitry comprising
transceiver circuitry configured to transmit and/or to receive signals;
control circuitry configured in combination with the transceiver circuitry to
transmit a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, wherein the configuration of the first frequency domain portion of the communications resources is different from a configuration of another, second frequency portion of the communications resources.

Paragraph 47. A wireless communications network comprising a communications device according to paragraph 43 and an infrastructure equipment according to paragraph 45

Paragraph 48. A computer program comprising instructions which, when the program is executed by a computer, cause the computer to carry out the method of paragraph 1 or paragraph 23.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RWS-210026, “On NR Full Duplex,” Qualcomm, 3GPP TSG RAN Rel-18 workshop, Jun. 28-Jul. 2, 2021.
[3] European patent No. 3545716.
[4] 3GPP TS38.211, “NR: Physical channels and modulation (Release 16)”
[5] 3GPP TS38.213, “NR: Physical layer procedures for control (Release 16)”

1. A method of operating a communications device configured to receive signals from a wireless communications network via a wireless access interface provided by the wireless communications network, the method comprising
receiving, by the communications device, a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, and in response the method comprises
configuring, by the communications device, the first frequency domain portion of the communications resources in accordance with the configuration indicated by the frequency resource indicator, wherein the configuration of the first frequency domain portion of the communications resources is different from a configuration of another, second frequency portion of the communications resources.

2. A method according to claim 1, wherein the configuring the first frequency domain portion of the communications resources in accordance with the configuration indicated by the communications resource indicator comprises
reconfiguring communications resources in the first frequency domain portion of the communications resources previously configured as uplink communications resources as downlink or flexible communications resources, or
reconfiguring communications resources in the first frequency domain portion of the communications resources previously configured as downlink communications resources as uplink or flexible communications resources.

3. A method according to claim 1, wherein the second frequency domain portion has been previously configured and the frequency resource indicator includes an indication that the second frequency domain portion of the communications resources should not be re-configured by the communications device.

4. A method according to claim 1, wherein the frequency domain indicator indicates to the communications device to configure the second frequency domain portion of the communications resources, and the frequency resource indicator indicates the configuration of the second frequency domain portion indicating whether communications resources in the second frequency domain portion should be configured as uplink, downlink or flexible resources.

5. A method according to claim 1, wherein the communications resources which can be used for communications between the communications device and the wireless communications network are divided in frequency into a plurality of bandwidth parts, the first frequency domain portion of the communications resources being one of the bandwidth parts as a first bandwidth part and the second frequency domain portion of the communications resources being another, different one of the bandwidth parts as a second bandwidth part.

6. A method according to claim 5, wherein the first and second bandwidth parts are each formed from a plurality of Orthogonal Frequency Division Multiplexing, OFDM, symbols, wherein the indication of the configuration of the first frequency domain portion including whether communications resources in the first frequency domain portion should be configured as uplink, downlink or flexible communications resources comprises
an indication of whether OFDM symbols in the first bandwidth part should be configured as uplink symbols reserved for uplink transmissions, downlink symbols reserved for downlink transmissions or flexible symbols which can be subsequently configured as either uplink or downlink symbols, and
the configuring the first frequency domain portion in accordance with the configuration indicated by the frequency resource indicator comprises
configuring one or more OFDM symbols in the first bandwidth part in accordance with the configuration indicated by the frequency resource indicator.

7. A method according to claim 6, comprising
determining, by the communications device, that one or more of the OFDM symbols for the first bandwidth part and the second bandwidth part overlap in time,
determining that the overlapping OFDM symbols are both uplink symbols, or both downlink symbols, or both flexible symbols, or one of the OFDM symbols is a flexible symbol and the other of the overlapping OFDM symbols is an uplink or a downlink symbol,
combining the overlapping OFDM symbols to form a third bandwidth part with a larger frequency range than the first or second bandwidth parts.

8. A method according to claim 6, wherein the indication of whether OFDM symbols in the first bandwidth part should be configured as uplink symbols reserved for uplink transmissions, downlink transmission reserved for downlink transmissions or flexible symbols which can be subsequently configured as either uplink or downlink symbols comprises
an indication that one or more of the OFDM symbols for the first bandwidth part should be configured as flexible symbols.

9. A method according to claim 8, comprising
receiving, by the communications device from the wireless communications network, an indicator scheduling an uplink or a downlink transmission on the one or more flexible symbols, and in response,
determining, by the communications device, that the one or more flexible symbols are uplink or downlink symbols respectively, and
transmitting the scheduled uplink transmission on the uplink symbols, or
receiving the scheduled downlink transmission on the downlink symbols.

10. A method according to claim 9, wherein the receiving the indicator scheduling an uplink or a downlink transmission on the one or more flexible symbols comprises
receiving a downlink control indicator, DCI, scheduling a downlink transmission on the one or more flexible symbols, and in response,
activating, by the communications device, the first bandwidth part for the scheduled downlink transmission, and the determining that the one or more flexible symbols are uplink or downlink OFDM symbols respectively comprises
determining that the one or more flexible symbols are downlink symbols, and
transmitting the scheduled downlink transmission on the downlink symbols.

11. A method according to any claim 1, wherein the frequency resource indicator is received in one or more Radio Resource Control, RRC, signals from the wireless communications network.

12. A method according to any claim 1, wherein the frequency resource indicator is received in one or more Slot Format Indicator, SFI, signals from the wireless communications network.

13. A method according to claim 12, wherein each of the one or more SFI indicator signals indicate to the communications device to configure one or more frequency portions the communications resources each corresponding to a different bandwidth part.

14. A method according to claim 12, wherein the one or more SFI indicator signals indicate to the communications device to configure one or more frequency domain portions of the communications resources each corresponding to a different bandwidth part for a pre-defined time duration.

15. A method according to claim 1, wherein the frequency resource indicator is received in one or more Medium Access Control, MAC, Control Element, CE, signals from the wireless communications network.

16. A method according to any claim 1, comprising
receiving, by the communications device, an indication of a previous configuration of the first frequency domain portion of the communications resources from the wireless communications network including an indication of whether communications resources in the first frequency domain portion are configured as uplink, downlink or flexible communications resources.

17. A method according to claim 16, wherein the previous configuration of the first frequency domain portion of the communications resources received from the wireless communications network is semi-statically configured by the wireless communications network.

18. A method according to claim 17, wherein the previous configuration of the first frequency domain portion of the communications resources received from the wireless communications network is a cell common semi-static slot format received in a system information block from the wireless communications network.

19.-43. (canceled)

44. Circuitry for a communications device configured to receive signals from a wireless communications network via a wireless access interface provided by the wireless communications network, the circuitry comprising
transceiver circuitry configured to transmit and/or to receive signals,
control circuitry configured in combination with the transceiver circuitry to
receive a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, and in response the control circuitry is configured in combination with the transceiver circuitry to
configure the first frequency domain portion of the communications resources in accordance with the configuration indicated by the frequency resource indicator, wherein the configuration of the first frequency domain portion of the communications resources is different from a configuration of another, second frequency portion of the communications resources.

45. (canceled)

46. Circuitry for an infrastructure equipment of a wireless communications network configured to transmit signals to a communications device via a wireless access interface provided by the wireless communications network, the circuitry comprising
transceiver circuitry configured to transmit and/or to receive signals;
control circuitry configured in combination with the transceiver circuitry to
transmit a frequency resource indicator indicating to the communications device to configure a first frequency domain portion of communications resources of the wireless access interface which can be used for communications between the communications device and the wireless communications network, the frequency resource indicator indicating a configuration of the first frequency domain portion of the communications resources including indicating whether communications resources in the first frequency domain portion should be configured as uplink communications resources reserved for uplink transmissions, as downlink communications resources reserved for downlink transmissions or as flexible communications resources which can be subsequently configured as uplink or downlink communications resources, wherein the configuration of the first frequency domain portion of the communications resources is different from a configuration of another, second frequency portion of the communications resources.

47.-48. (canceled)
